(19) United States
(12) Patent Application Publication
(10) Pub. No.: US 2026/0233948 A1
(43) Pub. Date: Aug. 13, 2026

(54) FACILITY FOR MANUFACTURING CONTAINERS, EQUIPPED WITH A SUCTION-EXTRACTION DEVICE

(71) Applicant: SIDEL PARTICIPATIONS, Octeville-sur-Mer (FR)

(72) Inventors: Jonas TONGA, OCTEVILLE- SUR-MER (FR); Matthieu EDDE, OCTEVILLE- SUR-MER (FR)

(21) Appl. No.: 19/533,817

(22) Filed: Feb. 9, 2026

(30) Foreign Application Priority Data
Feb. 10, 2025 (FR) 2501305

(51) Int. Cl. B65G 47/90; B08B 15/00; B29C 49/42; B29L 31/00

(52) U.S. Cl. CPC B65G 47/90; B08B 15/00; B29C 49/4282; B29L 2031/7158; B65G 2201/0244

(57) ABSTRACT

Disclosed are various embodiments of a facility for manufacturing thermoplastic containers, the facility having at least one device for conveying hollow bodies provided with a neck, having a frame fixed with respect to the ground and a gripping member for individually gripping a hollow body by its neck, which is movable along a production pathway. The facility has a suction-extraction device having at least one suction nozzle mounted on a structural element that is fixed with respect to the frame and which is arranged in the vicinity of a given region of the pathway of the necks of hollow bodies in order to extract dust generated by the rubbing of the hollow bodies as they pass through said given region without interfering with the travel thereof.

### CROSS-REFERENCE TO RELATED APPLICATIONS

This application claims the benefit of French Application No. FR2501305, filed Feb. 10, 2025, the entire contents of which is hereby incorporated herein by reference.

### BACKGROUND

It is known practice to manufacture containers by forming, in particular by stretch blow molding, preforms made of thermoplastic material, in particular of polyethylene terephthalate (PET) or of polypropylene (PP) in a manufacturing facility. During manufacture, it has been found that repeated rubbing of the containers against elements of certain conveying devices could cause the generation of microscopic thermoplastic material dust as a result of imperceptible abrasion of the container. Although the quantity of material removed on each passage is extremely low, the repeated passage of thousands of hollow bodies during mass production generates a non-negligible quantity of dust. Although the majority of this dust is discharged by a continuous atmosphere venting system, some of this dust remains trapped, for example by adhesion caused by static electricity, on the hollow bodies. The hollow bodies bring some of this dust into the enclosure of the filling device. Moreover, some of this dust can pass into the hollow body. Although the hollow body is cleaned at various locations in the manufacturing facility, if the dust passes into the hollow body just before it is filled, there is a risk of it mixing with the product filling the hollow body. To avoid these problems, it is known practice to regularly clean the various elements that are likely to trap dust before a level of contamination that does not comply with health standards is reached.

Although the quantities of dust are negligible from a health standpoint, and the risk of this dust getting into the containers is low, it is preferable to find a solution for permanently eliminating this type of problem. It is to the provision of a meeting these and other needs that the present invention is primarily directed.

### SUMMARY

Embodiments of the present disclosure provide a facility for manufacturing containers made of thermoplastic material, in particular bottles.

An embodiment of the present disclosure includes a facility having at least one device for conveying hollow bodies provided with a neck, the facility having a frame that is fixed with respect to the ground and at least one member for individually gripping a hollow body by its neck, which is movable along a production pathway. The facility includes a suction-extraction device having at least one suction nozzle which is mounted on a structural element that is fixed with respect to the frame and which is arranged in the vicinity of a given region of the pathway of the necks of hollow bodies in order to extract dust generated by the rubbing of the hollow bodies as they pass through said given region without interfering with the travel thereof.

In some embodiments, the suction nozzle has a mouth which has an elongate shape extending parallel to the direction of movement of the gripping members.

In some embodiments, the suction nozzle is mounted movably on the frame between an active extraction position, in which it is in the vicinity of the pathway of the gripping members in order to allow the extraction of the dust, and an inactive maintenance position, in which it is at a distance from the pathway of the gripping members.

In some embodiments, the suction nozzle is slidably guided along a direction orthogonal to the plane of the production pathway.

In some embodiments, the movements of the suction nozzle between its active position and its inactive position are carried out manually.

In some embodiments, the movements of the suction nozzle between its active position and its inactive position are carried out automatically via an actuator.

In some embodiments, the suction nozzle is locked in its respective active and inactive positions by an associated locking member.

In some embodiments, the conveying device has at least one fixed guide face intended to guide the hollow body by contact as it is moved by the gripping member, the given region being formed by the pathway portion of the hollow bodies in which the hollow bodies are in contact with the guide face.

In some embodiments, the conveying device has a rotating wheel on the frame, said wheel being provided with a plurality of gripping members distributed regularly on its periphery.

In some embodiments, each gripping member is formed by a notch that is open radially towards the outside.

In some embodiments, the facility has a unit for forming hollow bodies in the container state from hollow bodies in the preform state, the conveying device being arranged downstream of the forming unit.

In some embodiments, the forming unit is contained in an enclosure from which the hollow bodies exit via a pass-through window, the conveying device carrying the hollow bodies directly to the pass-through window.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a top view that schematically shows a container manufacturing facility produced according to various example embodiments;

FIG. 2 is a side view that shows a preform intended to be converted into a container by the manufacturing facility in FIG. 1;

FIG. 3 is a perspective view that shows only a conveying device of the manufacturing facility in FIG. 1;

FIG. 4 is a view in section on the section plane 4-4 in FIG. 5, which shows the conveying device in FIG. 3 conveying a hollow body and equipped with a suction-extraction device, according to various example embodiments;

FIG. 5 is a perspective view which shows a part of the manufacturing facility in FIG. 1, in which only the conveying device in FIG. 4 equipped with the suction-extraction device has been shown, the other conveying devices of the facility having been excluded for reasons of clarity of the drawing;

FIG. 6 is a detail view on a larger scale of FIG. 5, which shows a nozzle of the suction-extraction device arranged above a guide of the conveying device, according to various example embodiments;

FIG. 7 is a perspective view which shows only the nozzle of the suction-extraction device in FIG. 5;

FIG. 8 is a side view which shows the nozzle of the suction-extraction device in a first, low active position, according to various example embodiments;

FIG. 9 is a view similar to the one in FIG. 8, which shows the nozzle in a second, high inactive position, according to various example embodiments; and

FIG. 10 is a perspective view showing a device for guiding the nozzle between its active position and its inactive position, according to various example embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in °C, and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The terms used herein are intended to have their ordinary meaning unless specifically defined otherwise. Directional terms such as “upper,” “lower,” “front,” “back,” and similar terms are used for convenience and are not intended to be limiting unless the context clearly indicates otherwise. The use of “may,” “can,” “could,” and similar terms indicates possible embodiments and is not intended to limit the scope of the disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The longitudinal, vertical and transverse orientations will be adopted, in a non-limiting manner, with reference to the trihedron (L, V, T) shown in the figures.

The vertical direction is directed here in the direction of the Earth's gravity.

Use will also be made, in a non-limiting manner, of the terms “front” and “rear” with reference to the longitudinal direction, and “upper” and “lower” or “top” and “bottom” with reference to the vertical orientation, and finally “left” and “right” with reference to the transverse orientation.

The terms “upstream” or “downstream” are respectively used in relation to the direction of travel of the hollow bodies, preforms or containers, conveyed by the wheels of the conveying system through the manufacturing facility. “Hollow body” as used herein, refers to either a preform or a container.

### General Discussion

The mass production of containers is carried out in a manufacturing facility in which the hollow bodies travel along a predetermined production pathway. Each hollow body is handled by a succession of conveying devices which have members for individually gripping each hollow body. The hollow bodies are thus held individually along the entire production pathway from an entry point into the facility, in the preform state, to an exit point from the facility, in the container state.

When the preforms, which have been molded beforehand, are delivered, they are generally in the form of bulk products. It is therefore known practice to arrange a device for straightening and aligning the preforms at the entry to the facility, directly upstream of the entry point.

The material forming the preforms is generally in an amorphous state which does not allow them to be cold formed. Prior to the forming operation, the preforms are therefore heated to a temperature higher than or equal to a glass transition temperature which allows them to be shaped into a final container.

More particularly, the preforms generally have a body substantially in the form of a cylinder of revolution with a thick tubular wall which is closed at one of its axial ends by a thick-walled bottom, and which is continued at its other end by a neck, which is also tubular. The neck has been shaped into its final form and dimensions, whereas the body of the preform is intended to undergo relatively significant deformation in order to shape it into a container during a forming step.

For this reason, it is preferable for only the body of the preform to be heated to a setpoint temperature which is higher than the glass transition temperature, the neck remaining at a temperature lower than said glass transition temperature in order to avoid any deformation thereof during the manufacture of the container.

Such a production facility therefore has a thermal conditioning unit which makes it possible, during a heating step, to make the body of the preform malleable by heating it to the setpoint temperature. During the heating step, each preform is exposed to heating radiation while it is being moved. The power of the heating radiation is controlled so as to make it possible to heat the body of the preforms to a temperature higher than or equal to the setpoint temperature.

The production facility also has a forming unit, which is arranged downstream of the thermal conditioning unit along the direction of travel of the preforms in the production facility. During a forming step, the hot preform is placed in a forming station, for example in a mold of the forming unit which has a mold cavity in the shape of the container to be obtained. A pressurized fluid, such as air, is then injected into the malleable body of the preform in order to press its wall against the cavity of the mold. Generally, the injection of pressurized fluid is preceded and/or accompanied by axial stretching of the preform, in particular by a stretching rod inserted into the preform. In a known manner, the body is then subjected to biaxial stretching. The hollow bodies in the final container state which exit the forming unit are then carried to an exit of the manufacturing facility by a conveying device.

The manufacturing facility is generally combined with a facility for filling and capping the containers, which is arranged directly downstream of the exit point. Advantageously, the hollow bodies pass from the final conveying device of the manufacturing facility to the first conveying device of the filling facility continuously while still being held individually. The filling operation has to be carried out in a sterile zone in order to prevent contaminants from entering the container while it is being filled. The sterility conditions are particularly strict in the scope of filling containers with food products.

In this regard, it is already known to contain the filling device in a controlled atmosphere enclosure. The atmosphere of the enclosure is maintained under a positive pressure in order to avoid the ingress of dust and the air injected into the enclosure is filtered. Similar measures are taken in the enclosure of the forming unit in order to prevent the containers from being contaminated between the exit of the forming unit and the exit point of the facility.

These measures make it possible to comply with food standards entirely satisfactorily. The disclosure proposes going even further in the prevention of health risks by reducing the risk of contamination of the hollow bodies with even negligible quantities of dust from a health standpoint. It has been found that repeated rubbing of the containers against elements of certain conveying devices could cause the generation of microscopic thermoplastic material dust as a result of imperceptible abrasion of the container. For example, there is a fixed guide face with which the containers come into contact while they are being moved. According to another example, when the containers are carried by grippers and, while they are being transferred to the following device, the containers are disengaged from the grippers, this creates rubbing between the container and the jaws of the gripper.

Although the quantity of material removed on each passage is extremely low, the repeated passage of thousands of hollow bodies during mass production generates a non-negligible quantity of dust. Although the majority of this dust is discharged by a continuous atmosphere venting system, some of this dust remains trapped, for example by adhesion caused by static electricity, on the hollow bodies. The hollow bodies bring some of this dust into the enclosure of the filling device. Moreover, some of this dust can pass into the hollow body. Although the hollow body is cleaned at various locations in the manufacturing facility, if the dust passes into the hollow body just before it is filled, there is a risk of it mixing with the product filling the hollow body.

To avoid these problems, it is known practice to regularly clean the various elements that are likely to trap dust before a level of contamination that does not comply with health standards is reached. Although the quantities of dust are negligible from a health standpoint, and the risk of this dust getting into the containers is low, it is preferable to find a solution for permanently eliminating this type of problem.

In accordance with the purpose(s) of the present disclosure, as embodied and broadly described herein, embodiments of the present disclosure, in some aspects, relate to

In general, embodiments of the present disclosure provide for

An embodiment of the present disclosure includes

In various embodiments,

The present disclosure provides for

Turning now to the drawings, exemplary embodiments are described in detail.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

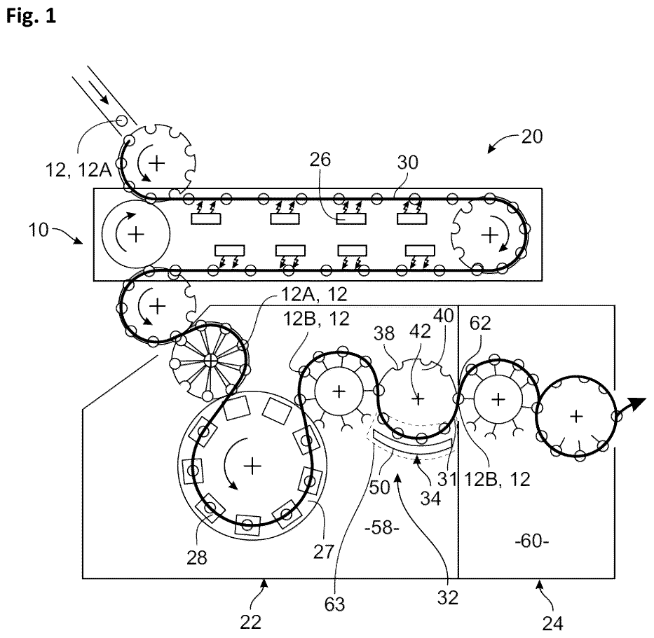

FIG. 1 shows an exemplary embodiment of a facility 10 for manufacturing containers 12B made of thermoplastic material.

Containers 12B such as bottles are manufactured from preforms 12A obtained in particular by injection moulding. In the following text, the preforms 12A and the containers 12B will be referred to by the common term “hollow body 12”.

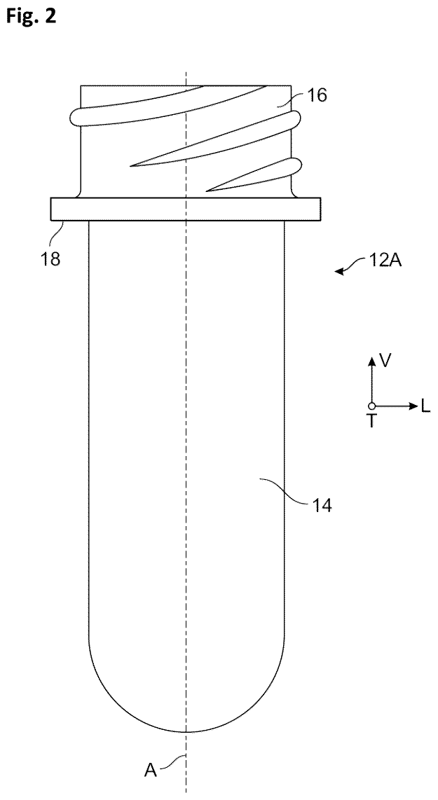

An example of a preform 12A intended to be used with the manufacturing facility 10 is illustrated in FIG. 2. Such a preform 12A is made of thermoplastic material, for example polyethylene terephthalate (PET) or polypropylene (PP). It is conventionally obtained by injection moulding. It has a substantially axisymmetric shape about a main axis “A” shown vertically in FIG. 2.

It has a body 14 in the form of an elongate tube extending along the main axis “A” and having a closed axial end, said tube having, at its opposite end, shown at the top in FIG. 2, an axially open neck 16. In the example shown in FIG. 2, the neck 16 has, at its junction with the body 14, a collar 18 which protrudes radially from the rest of the preform 12A.

The neck 16 exhibits its final shape, whereas the body 14 is intended to be stretched during a subsequent forming step in order to form the body of the finished container 12B.

The manufacturing facility 10 mainly has a thermal conditioning unit 20 and a forming unit 22. The manufacturing facility 10 is in this case coupled to a processing unit 24 arranged directly downstream of the forming unit 22. The processing unit 24 is preferably a filling unit, but it could also be a labelling unit or any other unit suitable for processing the containers 12B just after they have been formed.

The thermal conditioning unit 20 is intended to thermally condition the body 14 of the preforms 12A using heating members 26 such as infrared lamps or laser diodes. The preforms 12A heated in this way are then introduced into moulds 28 of the forming unit 22, in which they are converted into containers 12B by blow moulding or stretch blow moulding.

The forming unit 22 in this case has a rotating carousel 27, at the periphery of which the moulds 28 are arranged in order that the forming operation takes place while the hollow bodies 12 are being moved.

In the exemplary embodiment, the containers 12B obtained are transferred to the processing unit 24 arranged directly downstream.

In this manufacturing facility 10, the hollow bodies 12 are moved in a line along a common pathway, referred to as the production pathway 30, as far as an exit point 31 of the manufacturing facility 10. Along this production pathway 30, each hollow body 12 is held individually by its neck 16, and in particular by its collar 18, by gripping means of the conveying system 32. This makes it possible to prevent the hollow bodies 12 from coming into contact with one another and this also makes it possible to precisely know their position for undergoing the various treatments necessary for manufacturing the container 12B.

The preforms 12A and the containers 12B constitute objects that are identical to convey because they are provided with one and the same neck 16.

While it is being conveyed through the manufacturing facility 10 by such a conveying system 32, the hollow body 12 is either supported by way of its collar 18 or grasped at its neck 16 by a gripper, for example at an annular groove (not shown) located vertically above the collar 18.

In order to convey the hollow bodies 12, the conveying system 32 has a plurality of conveying devices which are designed to successively transport said hollow bodies 12 through the manufacturing facility 10, along the production pathway 30.

By way of non-limiting example, the conveying system 32 has in this case conveying devices of the rotating type, these being shown schematically in FIG. 1.

In the example, the conveying devices of the conveying system 32 are able to convey the hollow bodies 12 from one unit to the next.

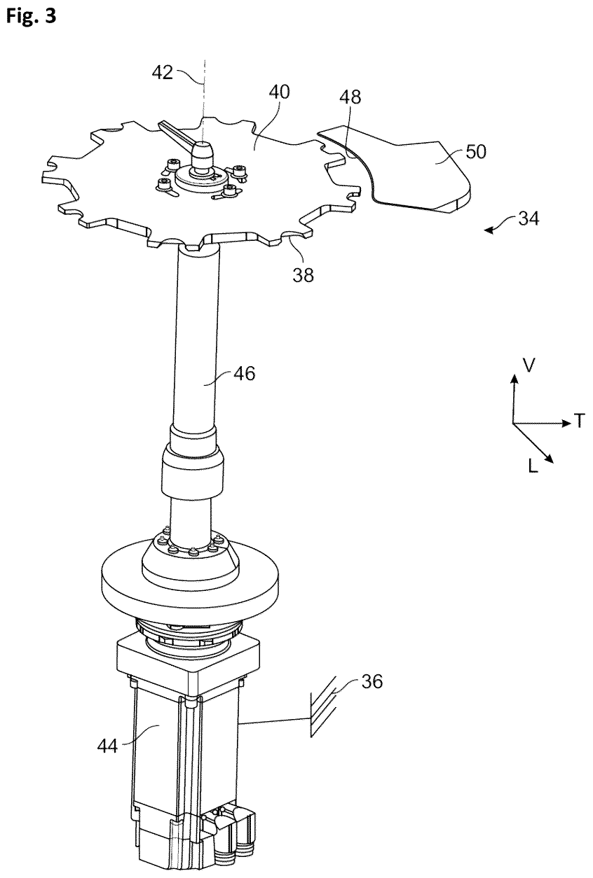

The conveying device 34 shown in FIG. 3 will be described in more detail. Such a conveying device 34 mainly has a frame 36 that is fixed with respect to the ground, shown schematically here.

The conveying device 34 has at least one member 38 for individually gripping a hollow body 12 by its neck 16, which is movable along a portion of the production pathway 30. Preferably, the conveying device 34 has a plurality of gripping members 38.

Each gripping member 38 is driven in movement along a closed circuit. In a portion of the circuit, each gripping member 38 holds a hollow body 12, whereas in the rest of the circuit, the gripping member 38 travels in an empty state in order to then pick up a new hollow body 12.

The gripping members 38 are motor-driven in movement along their closed circuit.

The closed circuit is in this case circular.

The conveying device 34 has a wheel 40 that is mounted rotatably on the frame 36 and is provided with a plurality of gripping members 38 distributed regularly at its periphery.

In the examples show in the figures, the wheel 40 rotates about a central axis 42 with respect to the frame 36. In this case, the central axis 42 is oriented vertically and the wheel 40 extends in a horizontal plane.

The wheel 40 is in this case driven in rotation by a motor 44 via a central shaft 46. The motor 44 is secured to the frame 36.

The gripping member 38 holds the hollow body 12 either by supporting its collar 18 or by grasping it in the region of the neck 16.

In the embodiment shown in the figures, each gripping member 38 is formed by a notch provided in an external peripheral edge of the wheel 40. Each notch is, for example, in the form of a “U” that is open radially towards the outside.

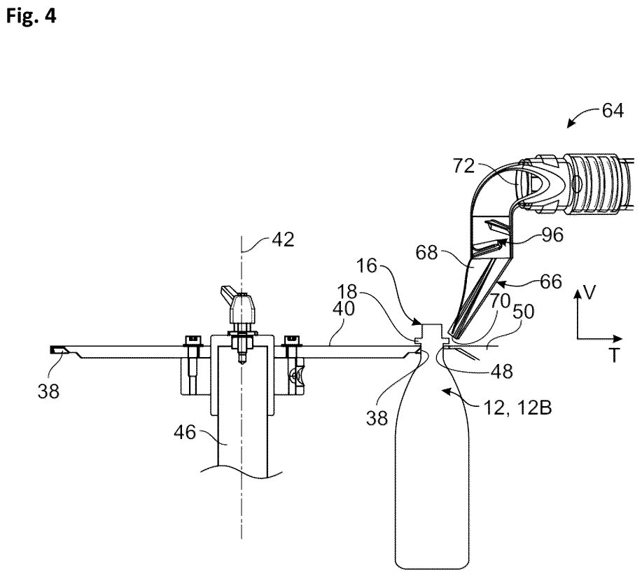

The hollow bodies 12 are introduced radially into the gripping member 38 in the form of a notch. As shown in FIG. 4, the hollow bodies 12 are supported via their collar 18. To this end, the collar 18 has a width greater than that of the notch so as to bear on an upper face of the wheel 40 around the perimeter of the notch. For this reason, such a conveying device 34 is sometimes referred to as a “notched wheel”.

The shape of each notch forming the gripping member 38 does not make it possible to radially retain the hollow body 12. To prevent the hollow bodies 12 from being ejected from their gripping member 38, in particular by centrifugal force during the rotation of the wheel 40, it is known practice to arrange at least one fixed guide face 48 on the frame 36 in order to guide the hollow body 12 by contact while it is being moved by the gripping member 38, and in particular to radially keep it in position in the notch forming the gripping member 38.

The guide face 48 is in this case carried by a guide 50 which is arranged along the pathway of the hollow bodies 12 transported by the gripping members 38. To this end, the guide 50 is in this case in the form of a ring segment.

The guide 50 is arranged such that the gripping members 38 pass radially next to the guide face 48. More particularly, the gripping members 38 and the guide 50 are in this case arranged in one and the same horizontal plane.

The guide face 48 is formed at least by the inner edge of the guide 50, which cooperates with the part of the hollow body 12 that is situated directly below the neck 16 in order to prevent it from exiting radially.

The guide face 48 may also have the upper face of the guide 50 at its inner perimeter. The upper face of the guide 50 thus helps to support the hollow body 12 by acting as a support for the collar 18, as shown in FIG. 4.

In a variant of the disclosure that is not shown, the gripping members 38 are formed by grippers which are arranged at the periphery of the rotating wheel 40. Each gripper is able to grasp the hollow body 12 by its neck 16, either below the collar 18 or above the collar 18.

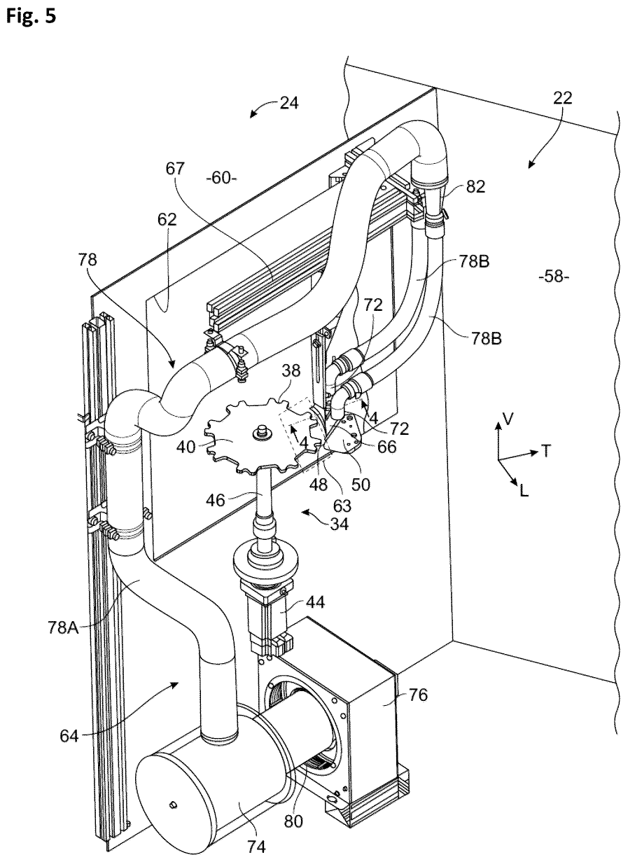

FIG. 5 shows only part of the facility in FIG. 1, straddling the forming unit 22 and the following processing unit 24, in this case the filling unit.

For hygiene reasons, the forming unit 22 is generally contained in an enclosure 58 which is kept under positive pressure compared with the surrounding pressure in order to prevent the ingress of dust and contaminating particles.

When the following processing unit 24 is a filling unit, it may also be contained in an enclosure 60 separate and different from the enclosure 58 of the forming unit 22. The enclosure 60 of the following processing unit 24 is kept sterile by positive pressure compared with that of the forming unit 22, since the filling operation has to be carried out under very strict hygiene and sterilization conditions.

The containers 12B pass from the forming unit 22 to the following processing unit 24 by passing through a window 62, the dimensions of which are designed to allow the containers 12B to pass through while minimizing the risk of the ingress of contaminating particles.

In the embodiment shown in the figures, the conveying device 34 is arranged inside the enclosure 58 of the forming unit 22. More particularly, the conveying device 34 is arranged downstream of the forming unit 22.

The conveying device 34 in this case forms the last conveying device on the production pathway 30 which carries the hollow bodies 12 directly to the pass-through window 62.

In a variant, the conveying device can be arranged at a different location in the manufacturing facility 10.

It has been found that the rubbing of the hollow bodies 12 against certain elements of the conveying device 34 while they are being moved causes the formation of dust by imperceptible abrasion of the hollow bodies 12. This abrasion takes place when the hollow bodies 12 pass through a given region 63 on their production pathway 30. The abrasion generally occurs at the neck 16 of the hollow bodies 12.

With reference to the example shown in the figures, the abrasion is formed in this case when the hollow bodies 12 travel in contact with the guide face 48 of the conveying device 34. The given zone 63 is thus formed by the portion of the pathway of the hollow bodies 12 in which the hollow bodies 12 are in contact with the guide face 48.

According to a variant of the disclosure that is not shown, the conveying device 34 has grippers and the abrasion takes place when the hollow bodies 12 are transferred to the downstream conveying device, in particular when the hollow bodies 12 are pulled out of their gripper by a gripping member of the conveying device directly downstream. In this case, the hollow bodies 12 rub against the jaws of the gripper, causing said abrasion that generates dust. The given zone 63 is thus formed by the portion of the pathway of the necks 16 that is situated at the point at which the hollow bodies are transferred from the conveying device to the conveying device directly downstream.

There is a risk of this dust contaminating the interior of the enclosure 58.

Moreover, when this dust sticks to the containers, in particular by attraction caused by static electricity, there is a risk of this dust being carried into the enclosure 60 of the processing unit 24, in this case the filling unit.

Moreover, there is a risk of this dust passing into the hollow body 12 and remaining trapped therein.

To solve this problem, the disclosure proposes extracting the dust directly at the location where it is generated.

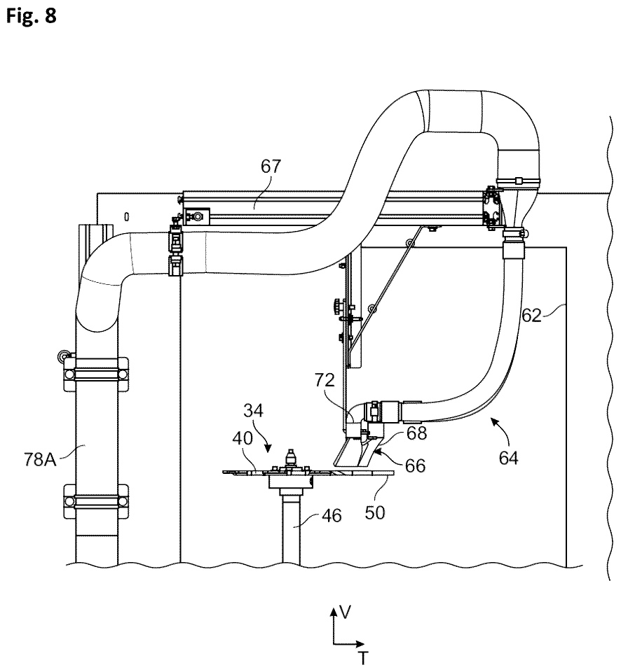

To this end, the manufacturing facility 10 has a suction-extraction device 64 having at least one suction nozzle 66, as shown in FIGS. 4 to 10. The suction nozzle 66 is mounted on a structural element 67 that is fixed with respect to the frame 36 so as to be kept in the vicinity of the pathway of the necks 16 of hollow bodies 12 in the given region 63 in order to make it possible to extract the dust generated by the rubbing of the hollow bodies 12 without interfering with the travel of the hollow bodies 12.

The nozzle 66 is, of course, arranged outside the hollow bodies 12 and does not move with the hollow bodies 12.

In the embodiment shown in the figures, the nozzle 66 is arranged at a sufficient distance from the guide face 48 to make it possible to extract the dust generated by the hollow bodies 12 rubbing against the guide face 48 without interfering with the travel of the hollow bodies 12.

The suction nozzle 66 is in this case mounted on a structural element of the enclosure 58. The structural element 67 is in this case a cross member of the ceiling of the enclosure 58.

The suction nozzle 66 mainly has a body 68 provided with an inlet mouth 70 through which the dust is sucked. The mouth 70 is arranged in the given region 63, in the vicinity of the pathway of the necks 16 of the hollow bodies 12.

The inlet mouth 70 is in this case arranged just above the upper face of the guide 50.

In the embodiment shown in FIGS. 4 to 10, the suction-extraction device 64 has a single suction nozzle 66.

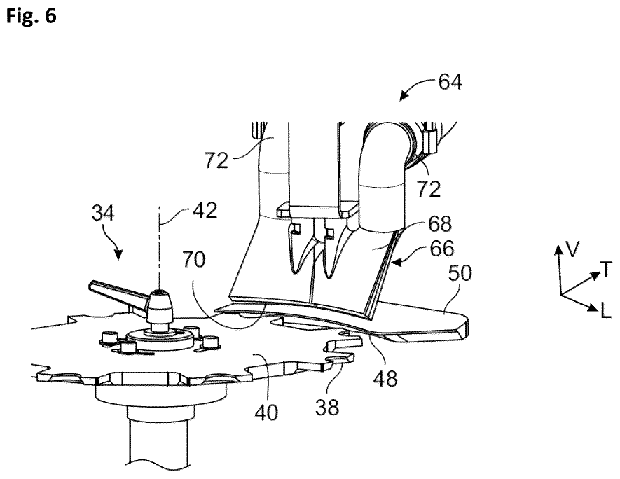

In order for it to be possible to extract the dust substantially along the entire length of the guide face 48, the mouth 70 has an elongate shape extending parallel to the direction of movement of the gripping members 38. The mouth 70 extends in this case parallel to the guide face 48, as shown in FIG. 6.

The suction nozzle 66 also has at least one outlet orifice 72 for the extracted dust.

The body 68 of the suction nozzle 66 extends generally vertically and is inclined such that the mouth 70 is arranged at a lower end in the vicinity of the pathway of the necks 16 of the hollow bodies 12, in this case in the vicinity of the guide face 48, while the at least one outlet orifice 72 is arranged vertically above the mouth 70 and is offset radially towards the outside, with respect to the axis 42 of rotation of the wheel 40. This arrangement makes it possible to free up a passage for the hollow bodies 12 travelling along the production pathway while arranging the mouth 70 as close as possible to the given region 63, in this case as close as possible to the guide face 48, as shown in FIG. 4.

As shown in FIG. 5, the suction-extraction device 64 also has a dust collector 74 and a negative-pressure source 76, such as a pump, via pipework 78.

By way of non-limiting example, the negative-pressure source 76 creates a negative pressure in the dust collector 74 in order to cause the dust to be sucked through the pipework 78 and the suction nozzle 66. Means are provided, such as a filter 80 for trapping the dust in the dust collector 74 and to prevent it from travelling onwards towards the negative-pressure source 76.

The negative-pressure source 76 is advantageously controlled such that it is possible to vary the value of the negative pressure and, consequently, the suction power. This makes it possible to benefit from a suction power that is sufficient to extract the dust without, however, causing the hollow bodies 12 to be lifted.

The pipework 78 in this case has a main suction pipe 78A, which is directly connected to an inlet orifice of the dust collector 74. The main pipe 78A is connected to the at least one dust outlet orifice 72 of the suction nozzle 66.

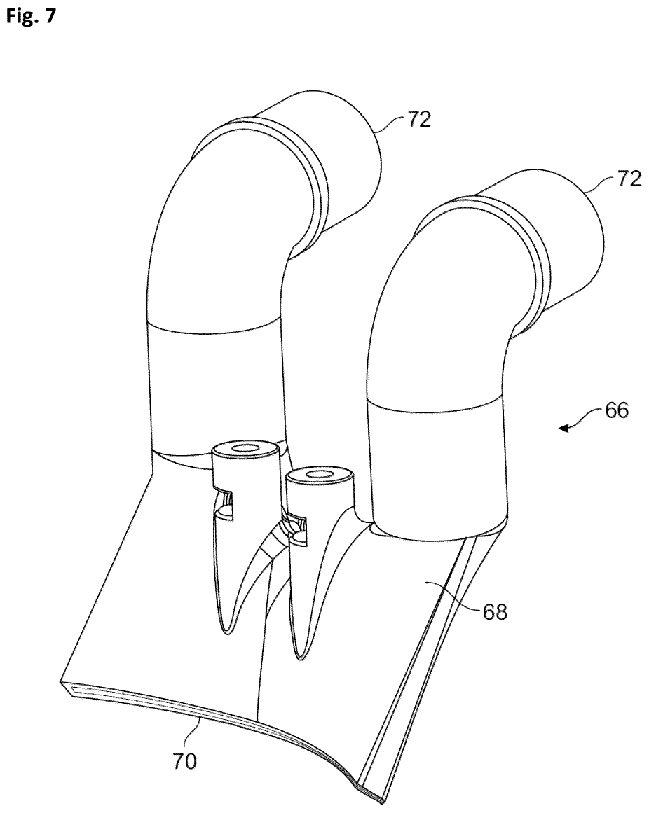

The mouth 70 has an elongate shape; it is preferable to distribute the suction force evenly along its entire length. To this end, the suction nozzle 66 has a plurality of outlet orifices 72, in this case two, as shown in FIG. 7. The outlet orifices 72 are distributed regularly along a line substantially parallel to the elongate shape of the mouth 70.

To this end, each outlet orifice 72 of the suction nozzle 66 is connected to the main pipe 78A via an associated secondary pipe 78B. Thus, the pipework 78 has two secondary pipes 78B which are connected to the main pipe 78A by a junction 82.

The secondary pipes 78B each have a flow cross section smaller than that of the main pipe 78A. Advantageously, the flow cross sections of the secondary pipes 78B are substantially equal to half the flow cross section of the main pipe 78A in order to avoid there being a loss of suction force between the main pipe 78A and the secondary pipes 78B.

In a variant of the disclosure that is not shown, the suction-extraction device 64 has a plurality of nozzles which are distributed along the guide face 48. This variant makes it possible to obtain the same result as with a single nozzle by effecting regular suction along the entire length of the guide face 48 by a plurality of nozzles. The nozzles can then be connected together or formed in one piece.

In a variant of the disclosure that is not shown, the nozzle 66 is connected directly to the main pipe 78A by a single outlet orifice 72. This arrangement advantageously makes it possible to reduce the pressure drops caused by excessively large changes in section.

The suction nozzle 66 takes up an active position, shown in FIGS. 4, 5, 6 and 8, while the manufacturing facility 10 is operating in a production mode, in which the hollow bodies 12 travel along the production path, being transported by the conveying device 34.

However, provision is made for it to be possible to replace certain elements of the conveying device 34, and in particular the guide 50 and the wheel 40, in order to adapt them to the conveying of hollow bodies 12 with different dimensions. This operation takes place when the manufacturing facility 10 is not in the production mode. In this regard, it is preferable to have clear access in order for it to be possible to remove these elements.

In a variant, when the conveying device comprises grippers, provides is made for it to be possible to change the grippers.

Therefore, provision is made for it to be possible to move the suction nozzle 66 in order to move it away from the gripping members 38 when the manufacturing facility 10 is not producing containers.

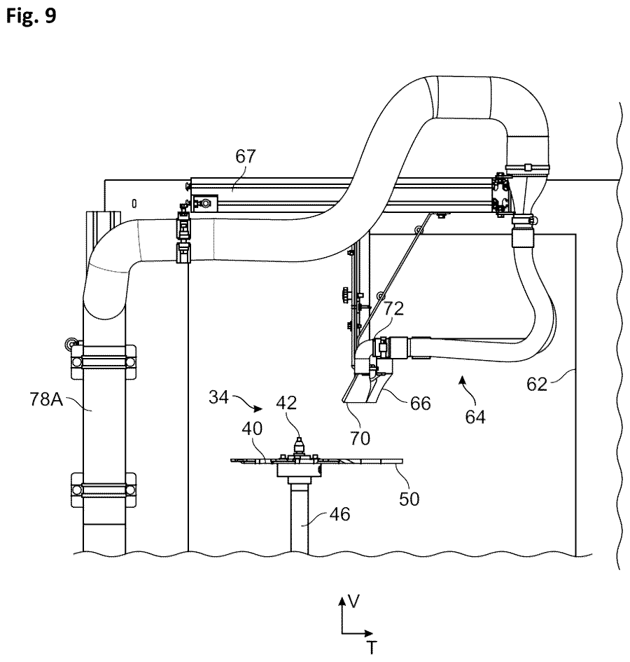

Preferably, the suction nozzle 66 is movable between the active suction position, in which it is in the vicinity of the gripping members 38 in order to allow the extraction of the dust, and an inactive maintenance position, in which it is at a distance from the gripping members, as shown in FIG. 9. Preferably, the suction nozzle 66 is guided while it is being moved between its two positions.

In the embodiment shown in the figures, the suction nozzle 66 is slidably guided along a direction orthogonal to the plane of the production pathway by way of a slide mechanism that is fixed with respect to the frame 36. The inactive position is in this case located vertically above the active position.

In a variant of the disclosure that is not shown, the suction nozzle 66 may also be pivotably mounted or mounted with a combination of pivoting and sliding.

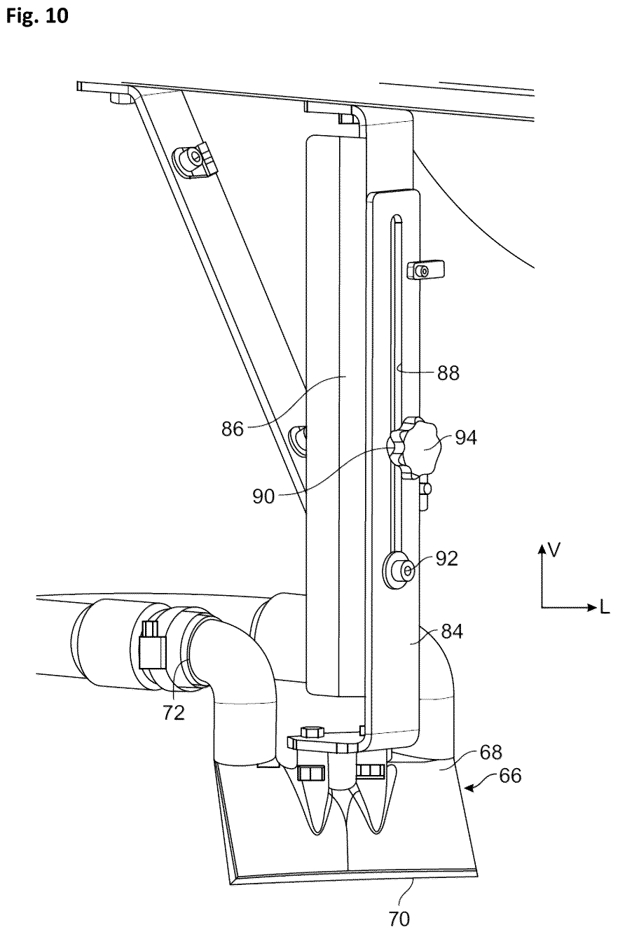

As shown in FIG. 10, the suction nozzle 66 is in this case secured to a carriage 84, which is itself slidably mounted vertically on a support 86. The support 86 is secured to the structural element 67.

In the embodiment shown, the carriage 84 has a vertical guide slot 88. The support 86 has two screws 90, 92 arranged in two securing orifices that are distributed vertically. The screws 90, 92 pass through the slot 88 in order to allow the slidable guidance.

The suction nozzle 66 is locked in its respective active and inactive positions by an associated locking member. The locking member is in this case formed by the upper screw 90, which can be screwed so as to clamp the carriage 84 between the support 86 and the head of the screw 90 in order to prevent the suction nozzle 66 from sliding. The screw 90 is advantageously provided with a thumb wheel 94 in order to be able to be manipulated easily without tools.

The movements of the suction nozzle 66 between its active position and its inactive position are in this case carried out manually.

In a variant of the disclosure that is not shown, the movements of the suction nozzle 66 between its active position and its inactive position are carried out by an actuator.

The suction nozzle 66 is preferably made of an antistatic material to avoid the adhesion of dust. It is made, for example, of a plastics material. Preferably, the material is compatible with current health standards; it is, for example, “polyamide 11” (PA11).

In order for it to be possible to adjust the position of the suction nozzle 66 radially, in particular when a guide 50 is replaced by a guide 50 with different dimensions in order for it to be possible to accommodate a different model of hollow bodies, provision is made for the suction nozzle 66 to be mounted adjustably on a support along a direction orthogonal to the production pathway and in the plane of the production pathway.

In order to avoid the space of the enclosure being cluttered by the pipework 78 of the suction-extraction device 64, the main pipe 78A is secured along the walls of the enclosure. The dust collector 74 is in this case arranged in the vicinity of the ground, under the conveying device 34, and it extends upwards along an upright and then as far as the ceiling of the enclosure. The secondary pipes 78B extend downwards from the ceiling as far as the suction nozzle 66.

The dust collector 74 is in this case arranged inside the enclosure 58 of the forming unit 22.

In a variant of the disclosure that is not shown, the dust collector 74 is arranged outside the enclosure 58. It is thus possible to empty it without waiting for a production stoppage while keeping the interior of the enclosure 58 sterile.

The two secondary pipes 78B are flexible so as to be able to accompany the movement of the suction nozzle 66 between its two positions. The fact that there are two secondary pipes 78B with a flow cross section smaller than that of the main pipe 78A makes it possible to obtain pipes that are more flexible and take up less space.

In a variant, the pipework 78 has only a main pipe.

On account of this arrangement, in the event of an untimely stoppage of suction, there is a risk of the dust contained in the secondary pipes 78B dropping back down towards the suction nozzle 66 under gravity. In order to prevent the dust from dropping back down as far as the mouth 70, chicanes 96 are provided in the outlet orifices 72 in order to retain the dust. The chicanes 96 are in this case formed by horizontal fins which extend partially through the outlet orifices 72, as shown in FIG. 4.

In a variant, the nozzle 66 does not have chicanes so as to reduce the pressure drops and thus increase the suction power.

The suction-extraction device 64 thus arranged in the vicinity of the guide face 48 located between the exit of the forming unit and the pass-through window makes it possible to extract the dust formed by rubbing against the hollow bodies in order to prevent contamination of the enclosure of the filling unit.

It is, of course, possible to arrange this suction-extraction device 64 on other conveyors of the manufacturing facility that are likely to cause the production of dust by rubbing of the hollow bodies.

Therefore, at least the following is claimed:

1. A facility for manufacturing containers made of thermoplastic material, in particular bottles, the facility having at least one conveying device for conveying hollow bodies provided with a neck, having:
a frame that is fixed with respect to a ground surface;
at least one gripping member for individually gripping a hollow body by the neck, which is movable along a production pathway; and
a suction-extraction device having at least one suction nozzle, wherein the suction-extraction device is mounted on a structural element that is fixed with respect to the frame and that is arranged in a vicinity of a given region of the production pathway in order to extract dust generated by rubbing of the hollow bodies as the hollow bodies pass through said given region without interfering with travel thereof.

2. The facility according to claim 1, wherein the suction nozzle has a mouth having an elongate shape extending parallel to a direction of movement of the gripping members.

3. The facility according to claim 1, wherein the suction nozzle is mounted movably on the frame between an active extraction position in which the suction nozzle is configured to extract dust from along the production pathway, and an inactive maintenance position in which the suction nozzle is at a distance from the pathway of the gripping members so as not to extract dust from along the production pathway.

4. The facility according to claim 3, wherein the suction nozzle is slidably guided along a direction orthogonal to a plane of the production pathway.

5. The facility according to claim 3, wherein movements of the suction nozzle between the active position and the inactive position are carried out manually.

6. The facility according to claim 3, wherein movements of the suction nozzle between the active position and the inactive position are carried out automatically via an actuator.

7. The facility according to claim 3, wherein the suction nozzle is locked in respective active and inactive positions by an associated locking member.

8. The facility according to claim 1, wherein the conveying device comprises at least one fixed guide face configured to guide the hollow body by contact as the hollow body is moved by the gripping member, a given region being formed by a pathway portion of the hollow bodies in which the hollow bodies are in contact with the guide face.

9. The facility according to claim 1, wherein the conveying device comprises a rotating wheel on the frame, the wheel being provided with a plurality of gripping members distributed regularly on a periphery.

10. The facility according to claim 9, wherein each gripping member is formed by a notch that is open radially towards an outside of the wheel.

11. The facility according to claim 1, the facility further comprising a forming unit for forming hollow bodies in a container state from hollow bodies in a preform state, the conveying device being arranged downstream of the forming unit.

12. The facility according to claim 11, wherein the forming unit is contained in an enclosure from which the hollow bodies exit via a pass-through window, the conveying device carrying the hollow bodies directly to the pass-through window.

13. A facility for manufacturing containers made of thermoplastic material, in particular bottles, the facility having at least one conveying device for conveying hollow bodies provided with a neck, having:
a frame that is fixed with respect to a ground surface;
at least one gripping member for individually gripping a hollow body by the neck, which is movable along a production pathway; and
a suction-extraction device having at least one suction nozzle, wherein the suction-extraction device is mounted on a structural element that is fixed with respect to the frame and that is arranged in a vicinity of a given region of the production pathway in order to extract dust generated by rubbing of the hollow bodies as the hollow bodies pass through said given region without interfering with travel thereof;
wherein the suction nozzle has a mouth having an elongate shape extending parallel to a direction of movement of the gripping member and is slidably guided along a direction orthogonal to a plane of the production pathway; and
wherein the suction nozzle is mounted movably on the frame between an active extraction position in which the suction nozzle is configured to extract dust from along the production pathway, and an inactive maintenance position in which the suction nozzle is at a distance from the pathway of the gripping members so as not to extract dust from along the production pathway.

14. The facility according to claim 13, wherein the suction nozzle is slidably guided along a direction orthogonal to a plane of the production pathway.

15. The facility according to claim 13, wherein movements of the suction nozzle between the active position and the inactive position are carried out manually.

16. The facility according to claim 13, wherein movements of the suction nozzle between the active position and the inactive position are carried out automatically via an actuator.

17. The facility according to claim 13, wherein the suction nozzle is locked in respective active and inactive positions by an associated locking member.

18. The facility according to claim 13, wherein the conveying device comprises a rotating wheel on the frame, the wheel being provided with a plurality of gripping members distributed regularly on a periphery, wherein each gripping member is formed by a notch that is open radially towards an outside of the wheel.

19. The facility according to claim 13, the facility further comprising a forming unit for forming hollow bodies in a container state from hollow bodies in a preform state, the conveying device being arranged downstream of the forming unit.

20. The facility according to claim 19, wherein the forming unit is contained in an enclosure from which the hollow bodies exit via a pass-through window, the conveying device carrying the hollow bodies directly to the pass-through window.
